(19) United States
(12) Patent Application Publication
(10) Pub. No.: US 2012/0130900 A1
(43) Pub. Date: May 24, 2012

(54) System and Method for Trading Unused Digital Rights

(75) Inventors: Polly Tang, San Diego, CA (US); Petr Peterka, San Diego, CA (US)

(73) Assignee: GENERAL INSTRUMENT CORPORATION, Horsham, PA (US)

(21) Appl. No.: 12/950,678

(22) Filed: Nov. 19, 2010

(51) Int. Cl. G06Q 30/00; G06F 21/24

(52) U.S. Cl. 705/59

(57) ABSTRACT

A device is provided for use with a digital content provider and a content purchaser. The content provider can provide digital content and a first digital key, wherein the digital content has quantified digital rights associated therewith. The device includes a receiving portion, a security portion, a content database, an interface portion and a transmitting portion. The receiving portion can receive the digital content and the first digital key. The security portion can access the digital content with the first digital key. The content database can store the digital content. The interface portion can offer to the content purchaser the digital content and can enable the content purchaser to purchase the digital content in accordance with purchased quantified digital rights. The security portion can further encrypt the digital content with a second digital key such that the content purchaser may use the purchased digital content.

### BACKGROUND

The growth of electronics and computers has altered the landscape of music, television and cinema. Music, television and cinema increasingly offer digitized content to allow for modern consumers to access this content with greater ease than previous generations. Non-limiting examples of digitized content includes a movie, television show or music along with associated digital rights. Digital rights govern the use of the digitized content, non-limiting examples include constraints that may be placed on copying ability, number of plays, and time period of usage. An exemplary case of acquiring digitized content with be discussed below.

Assume in case 1: Consumer A acquires digitized content for a Movie Z, which has digital rights that limits the number of times Consumer A may watch Movie Z; assume the number of viewing times is five. After five viewings, Consumer A would have no remaining digital rights to the digitized content Movie Z. If Consumer A decides that after one viewing that they do not want to view Movie Z anymore, remaining four viewings are left unusable. In case 2, assume that Consumer B acquires digitized content for Movie Z, which has digital right that limits the time period in which Consumer B can view Movie Z; assume the usage period is one month. (After one month Consumer B would have no digital rights to the digitized content Movie Z). Note, if after a single viewing, Consumer B decides after one week he no longer wishes to have the digital rights to view Movie Z he is left with no recourse.

As shown in the two exemplary cases above, currently there is no device or system that addresses fallow digital rights. What is needed is a device or system that permits developing a market for-fallow digital rights.

### BRIEF SUMMARY

The present invention provides a device that allows for the transfer of quantified digital rights not used by the owner to those who want those unused quantified digital rights.

In accordance with an aspect of the present invention, a device is provided for use by a digital content provider and a content purchaser. The content provider can provide digital content and a first digital key, wherein the digital content has quantified digital rights associated therewith. The content purchaser can use the digital content in accordance with the digital rights upon receipt of the digital content and a second key. The device includes a receiving portion, a security portion, a content database, an interface portion and a transmitting portion. The receiving portion can receive the digital content and the first digital key from the digital content provider. The security portion can access the digital content with the first digital key. The content database can store the digital content. The interface portion can offer to the content purchaser the digital content in accordance with the quantified digital rights and can enable the content purchaser to purchase the digital content in accordance with purchased quantified digital rights that have a quantity that is no more than the quantity of the quantified digital rights. The security portion can further encrypt the digital content with a second digital key such that the content purchaser may use the purchased digital content in accordance with the purchased quantified digital rights. The transmitting portion can transmit the encrypted digital content and the second digital key to the content purchaser.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a content acquiring system in accordance with an aspect of the present invention;

FIG. 2 illustrates a conventional process of obtaining new content via the content acquiring system from FIG. 1;

FIG. 3 illustrates a content trading system in accordance to an aspect of the present invention;

FIG. 4 illustrates content trading system from FIG. 3 communicating with content purchasers from FIG. 3 and content providers;

FIG. 5 illustrates a content transaction process amongst the devices of FIG. 4;

FIG. 6 illustrates an exemplary pricing list;

FIG. 7 illustrates an exemplary content sale process from the first content purchaser of FIG. 4 to the content trading device of FIG. 3;

FIG. 8 illustrates an exemplary content purchasing process the first content purchaser of FIG. 4 to the content trading device of FIG. 3;

FIG. 9 illustrates an exemplary content gifting process from the first content purchaser of FIG. 4 to the second content purchaser of FIG. 4; and

FIG. 10 illustrates an exemplary content transfer from the first content purchaser of FIG. 4 to an unknown second content purchaser of FIG. 4.

### DETAILED DESCRIPTION

The problem of fallow digital rights amongst content purchasers is solved by introducing a content trading device that interacts between content providers and content purchasers. In example embodiments, this content trading device enables: Sale of unused quantified digital rights; Purchase of unused quantified digital rights; Gifting of unused quantified digital rights to a known party; and, Transfer of unused quantified digital rights to an unknown party.

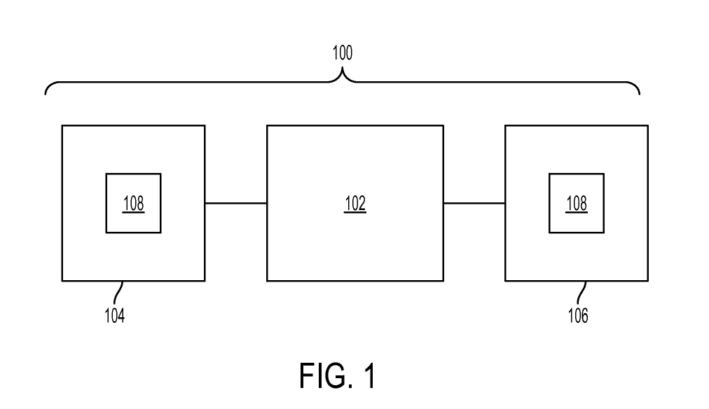

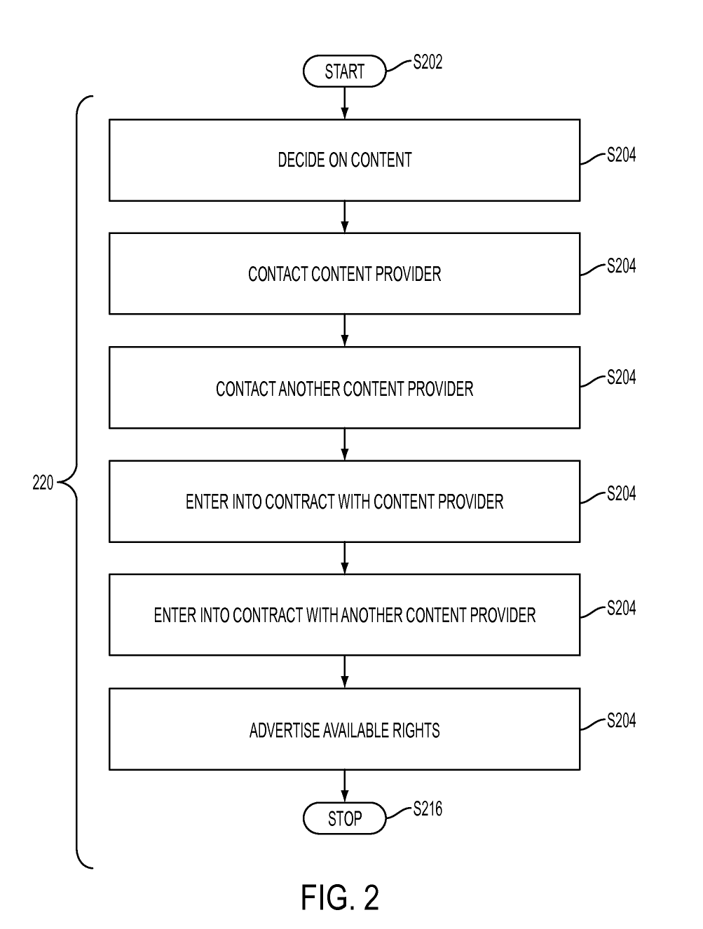

Prior to trading content amongst content providers and content purchasers, the content must be first obtained. FIG. 1 and FIG. 2 described below provide a system for acquiring content and an exemplary process for acquiring the content via the system for acquiring content.

FIG. 1 illustrates a content acquiring system 100 in accordance with an aspect of the present invention.

Content acquiring system 100 includes a content trading device 102, a first content provider 104 and a second content provider 106. Content device 102, first content provider 104 and second content provider 106 are connected in such a manner that allows for content device 102 and first content provider 104 to securely communicate between the two devices and also allows for content device 102 and second content provider 106 to communicate securely to each other. The connection between content device 102 and first content provider 104 and the connection between content device 102 and second content provider 106 may be wireless or wired.

First content provider 104 is configured to provide digital content and a digital key via a transceiver 108. Second content provider 106 is also configured to provide digital content and a digital key via a transceiver 110. The digital content of first content provider 104 and second content provider 106 are configured to have quantified digital rights associated with the digital content. Transceivers 108 and 110 are both configured to transmit and receive data. First content provider 104 and second content provider 106 do not engage in business with each other. The quantified digital rights purchased from first content provider 104 cannot be switched to quantified digital rights from second content provider 106 by going to first content provider 104 or second content provider 106 directly or vice versa. First content provider 104 and second content provider 106 each have their own set of quantified digital rights for the same content for sale.

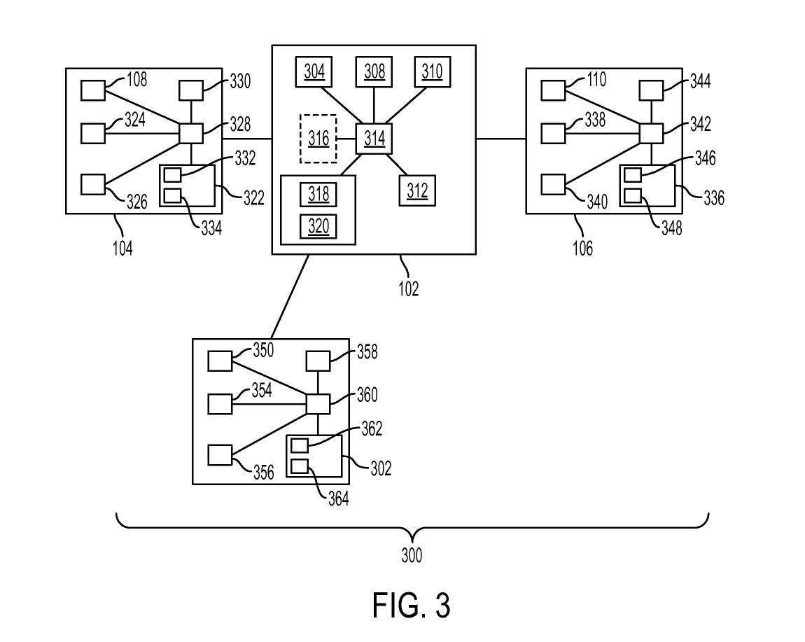

Content trading device 102 will be described in more detail with reference to FIG. 3, below. The operation of content acquiring system 100 will now be described with reference to FIG. 1 and FIG. 2.

FIG. 2 illustrates a conventional process 200 of content acquisition between content trading device 102, first content provider 104 and second content provider 106.

After process 200 starts (S202), content trading device 102 decides on what content to acquire (S204). For example, content trading device 102 may desire Movie X.

Content trading device 102 then proceeds to contact a content provider (S206). For example, content trading device 102 contacts first content provider 104 and learns the types of rights that first content provider 104 can provide for Movie X.

In order to provide different rights options for the same content, content trading device 102 proceeds to contact another content provider (S208). For example, content trading device 102 contacts second content provider 106 and learns the types of rights that second content provider 106 can provide for Movie X.

Content trading device 102 proceeds to engage in a contract with a content provider (S210). For example, content trading device 102 and first content provider 104 enter into a contract. This contract allows content trading device 102 to buy and sell back the rights that first content provider 104 can provide for Movie X.

As mentioned above, content trading device 102 desires to provide different rights options for the same content. For those reasons, content trading device 102 proceeds to engage in a contract with another content provider (S212). Content trading device 102 engages in a contract to buy and sell back the rights that second content provider 106 can provide for Movie X.

Content trading device 102 desires to offer digital content rights for sale, and therefore proceeds to advertise available rights packages (S214). For example, these different rights packages may pertain to rights acquired from first content provider 104 and second content provider 106 for the content Movie X. Content acquisition process 200 ends at S214.

After the content is acquired by content trading device 102 content trading may begin as is shown in the remaining figures.

According to aspects of the present invention, a content trading system, which includes content trading device 102, will now be described in greater detail with reference to FIG. 3.

FIG. 3 illustrates content trading system 300 in accordance with an aspect of the present invention.

Content trading system 300 includes content trading device 102, first content provider 104, second content provider 106 and first content purchaser 302.

Content trading device 102 includes a receiving portion 304, a security portion 306, a content database 308, an interface portion 310, a transmitting portion 312, and a processing portion 314. Optionally, content trading device 102 may also include a points management server 316. Security portion 306 includes a license validation server 318 and a crypto-agent 320.

First content provider 104 includes transceiver 108, a security portion 322, a content database 324, an interface portion 326, a processing portion 328, and a cache server 330. Security portion 322 includes a license validation server 332 and a crypto-agent 334.

Second content provider 106 includes transceiver 110, a security portion 336, a content database 338, an interface portion 340, a processing portion 342, and a cache server 344. Security portion 336 includes a license validation server 346 and a crypto-agent 348.

First content purchaser 302 includes a receiving portion 350, a security portion 352, a content database 354, an interface portion 356, a transmitting portion 358, and a processing portion 360. Security portion 352 includes a license management server 362 and a crypto-agent 364.

Receiving portions 304 and 350 are both configured to receive data. Security portions 306, 322, 336, and 352 are similarly configured to protect data. Content databases 308, 324, 338, and 354 are similarly configured to store content. Interface portions 310, 326, 340, and 356 are similarly configured to allow for user interaction. Transmitting portions 312 and 358 are both configured to send data. Processing portions 314, 328, 342, and 360 are configured to aid in the operation of their respective devices. Points management server 316 is configured to manage any points that may be associated with digital content. License validation servers 318, 332, and 346 as well as license management server 362 are similarly configured to manage and validate licenses over the Internet. Crypto-agents 320, 334, 348, and 364 are similarly configured to protect data via cryptography. Cache servers 330 and 344 are similarly configured to store Internet content locally.

Content trading device 102 is connected to first content provider 104, second content provider 106, and first content purchaser 302 via a wireless or wired connection.

The first content purchaser 302 is configured to use the digital content originating from first content provider 104 or second content provider 106 in accordance with the digital rights upon the receipt of the digital content and a second key. Receiving portion 304 is configured to receive the digital content and the first digital key from either the first content provider 104 or the second content provider 106. Security portion 306 is configured to access the digital content received with the first digital key. Content database 308 is configured to store the digital content received. Interface portion 310 is configured to offer to the first content purchaser 302, the digital content received in accordance with the quantified digital rights associated therewith. Interface portion 310 is further configured to enable the first content purchaser 302 to purchase the digital content received in accordance with the purchased quantified digital rights that have a quantity that is no more than the quantity of the quantified digital rights. Security portion 306 is further configured to encrypt the digital content received with a second digital key such that the first content purchaser 302 may use the purchased digital content in accordance with the purchased quantified digital rights. Transmitting portion 312 is configured to transmit the encrypted digital content and the second digital key to the first content purchaser 302. Processing portion 314 is configured to operate and communicate between the receiving portion 304, the security portion 306, the content database 308, the interface portion 310 and the transmitting portion 312

In an example embodiment, interface portion 310 is further configured to offer to purchase-remaining quantified digital rights, that have a quantity that is no more than the quantity of the purchased quantified digital right, from the first content purchaser 302.

In another example embodiment, receiving portion 304 is further configured to receive the remaining quantified digital rights from the first content purchaser 302.

In another embodiment, interface portion 310 is further configured to offer the digital content in accordance rights with the unused, residual, quantified digital rights. Interface portion 310 also enables a second purchase of the digital content in accordance with a second purchased quantified digital rights that have a quantity that is no more than the quantity of the quantified digital rights, minus the purchased quantified digital rights and plus the remaining quantified digital rights.

In yet another embodiment, security portion 306 is further configured to encrypt the digital content with a third digital key associated with the second purchase.

In another embodiment, transmitting portion 312 is further configured to transmit the encrypted digital content and the third digital key.

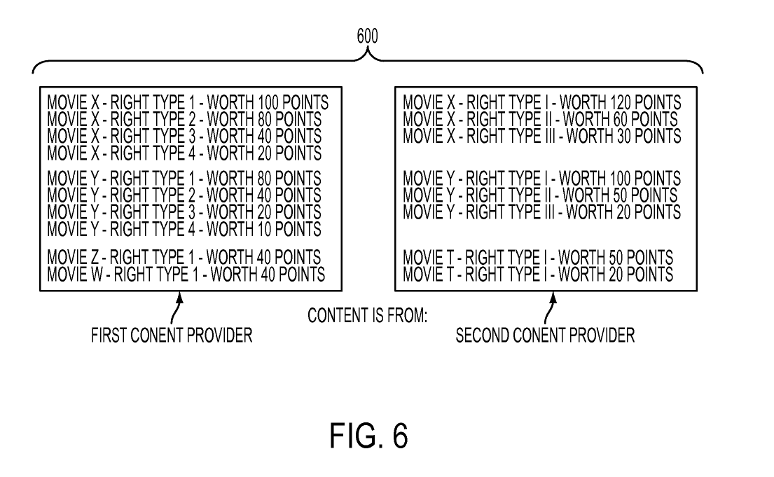

In operation, content trading device 102 is in communication with first content provider 104, second content provider 106, and first content purchaser 302. First content purchaser 302 accesses content trading device 102 via interface portion 310. First content purchaser 302 is then able to enter into a number of transactions that are facilitated by content trading device 102. These different transactions will be discussed in more detail below with reference to FIGS. 6-10. Irrespective of the type of transaction content trading device 102 facilitates, content trading device 102 must perform at least one of two duties, delivering the rights which a purchaser has paid for and validating a license and rights from a seller. These duties will be discussed now.

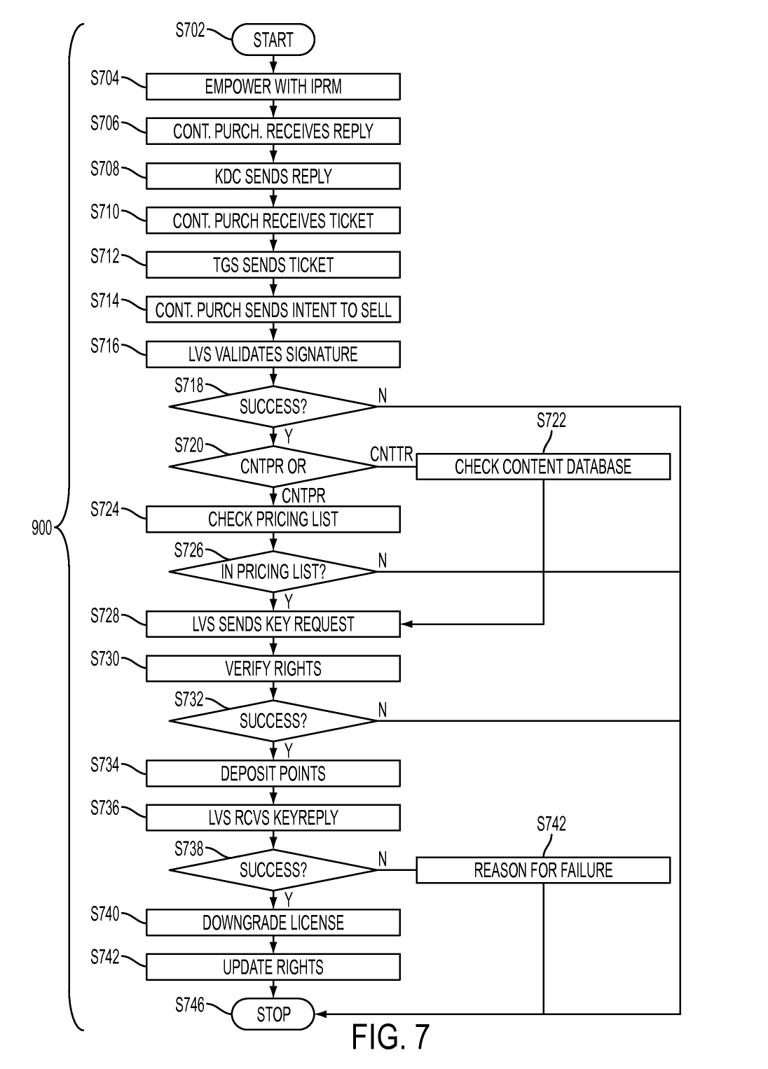

The first duty to be discussed is the delivery of rights to a purchaser after receipt of payment. Two embodiments will be discussed and it is assumed in both embodiments that content trading device 102, first content purchaser 302, and first content provider 104 all use IPRM (Internet Protocol Rights Management). A more detailed discussion of IPRM is found in the discussion of FIG. 7.

In one example embodiment, a license is generated locally at content trading device 102. Content trading device 102 receives communication via receiving portion 304 from first content purchaser 302. This communication contains the desired rights type, Content ID (the movie name), the content provider (such as first content provider 104), and a corresponding URL (uniform resource locator) if existent. Based on this information, content trading device 102, via security portion 306, generates a SRO (security right object) and a DOI (digital object identification) at the same time. The SRO and DOI are sent via transmitting portion 312 to first content purchaser 302. First content purchaser 302 forwards the SRO to first content provider 104. First content provider 104 generates a content key and encrypts the content via crypto agent 334. The content key is sent back to first content purchaser 302. The first content purchaser 302 can then download the movie. The first content purchaser 302 can use DOI information to create a license for the content. The DOI contains the information on the movie title and the rights type purchased. The license will contain the rights type that represents the rights purchased from content trading device 102, the movie title and the transaction number with content trading device 102. The rights type also represents the remaining quantified digital rights that will be tracked by license management server 362. The movie title and the transaction number are for content trading device 102 to validate the license in future trading.

An alternative way of delivering the rights that a purchaser has paid for is described below. License validation server 318 generates the license. Security portion 306 hosts multiple license servers such as OMA, Janus etc. and is able to generate the license on behalf of first content purchaser 302. The license contains a content pre-encryption key, which has to be obtained from first content provider 104. For example, Content trading device 102 has to send a request message via transmitting portion 312 to first content provider 104, which then sends back the pre-encryption key to receiving portion 304 of content trading device 102. The pre-encryption key will be used by security portion 306 in the license creation. The license will then be sent back via transmitting portion 312 to first content purchaser 302 (content trading device 102 generates the format of a license that it can recognize). First content purchaser 302 may then go to interface portion 326 of first content provider 102 to download the content.

A second duty that content trading device 102 performs is validating license and rights from a seller. This is done to protect against the threat of alteration of remaining quantified digital rights in the license. Two embodiments will be discussed and it is assumed in both embodiments that content trading device 102, first content purchaser 302, and first content provider 104 all use IPRM. As mentioned above a more detailed discussion of IPRM is found in the discussion of FIG. 7.

In one example embodiment, content trading device 102 generates a license locally using IPRM as DRM via security portion 306. In order for content trading device 102 to validate the remaining rights of a license, which are signed by license management server 362 of first content purchaser 302, the license management server 362 must have its public signing key available to content trading device 102 via security portion 306. Also the license must contain a digital signature based on the whole license. Prior to content trading device 102 sending a SRO via transmitting portion 312 to another purchaser, license management server 362 will log the information from the SRO into content database 354 of first content purchaser 302. This is done to prevent first content purchaser 302 selling the rights again because content trading device 102 compares its record against content database 354.

These two measures form a dual protection against theft. The remaining quantified digital rights cannot exceed the original rights recorded in content trading device 102. In the case the quantified digital rights are counted playbacks and a very solid check against threat is required, one way to do this is to use an authenticated message exchange between first content purchasers 302 license management server 362 and content trading device 102 and vice versa. This is done via the Internet prior to each playback and allows for content trading device 102 to accurately keep track of the number of playbacks already rendered.

An alternative way for content trading 102 to validate a license and digital rights from a seller is described as follows. In this exemplary embodiment, the license is generated by license validation server 318 of security portion 306, which makes use of various license servers such as OMA or Janus. The remaining quantified digital rights are tracked by license management server 362 in first content purchaser 302. Also the license contains a digital signature signed by license management server 362 of first content purchaser 302. A public signing key of the license management server 362 must be available to content trading device 102 in order for content trading device 102 to validate the remaining rights in the license. The best check content trading device 102 can perform is to validate the signature via license validation server 318 and compare the remaining quantified digital rights in content database 354 of first content purchaser 302 so that the remaining rights may never exceed the original rights in the license.

In either of the two examples, for content trading device 302 to validate a license and rights from a seller described above, content trading device 102 will deal or handle a first content purchaser 302 only if its license is issued by content trading device 102. This is because it is difficult for content trading device 102 to validate some other party's issued license without possessing the issuer's authentication MAC (Media Access Control) key.

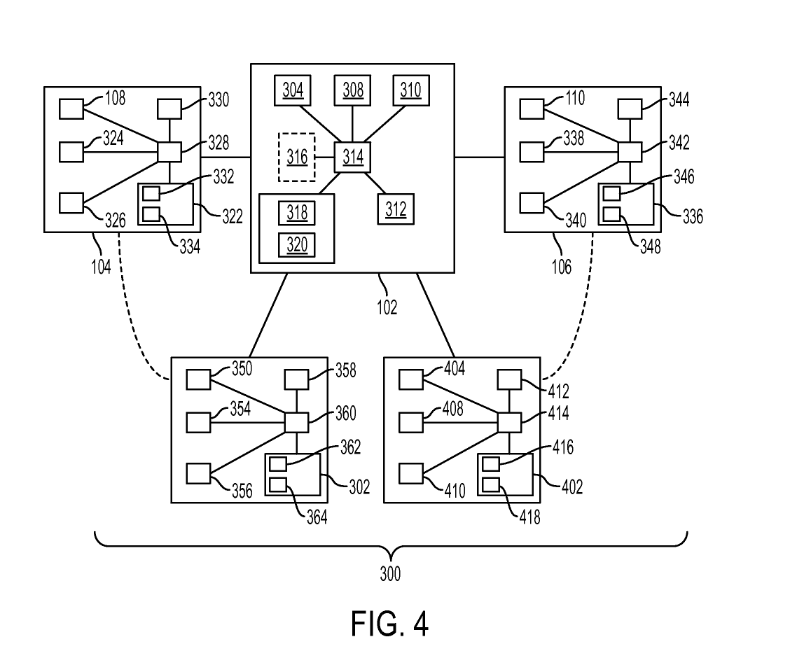

FIG. 4 illustrates content trading system 300 communicating with first content purchaser 302 and a second content purchaser 402 and content providers 104 and 106.

Second content purchaser 402 includes a receiving portion 404, a security portion 406, a content database 408, an interface portion 410, a transmitting portion 412, and a processing portion 414. Security portion 406 includes a license management server 416 and a crypto-agent 418.

Receiving portion 404 is configured similarly to receiving portions 304 and 350. Security portion 406 is configured similarly to security portions 306, 322, 336, and 352. Content database 408 is configured similarly to content databases 308, 324, 338, and 354. Interface portion 410 is configured similarly to interface portions 310, 326, 340, and 356. Transmitting portion 412 is configured similarly to transmitting portions 312 and 358. Processing portion 414 is configured similarly to processing portions 314, 328, 342, and 360. License management server 416 is configured similarly to license management server 362. Crypto agent 418 is configured similarly to crypto agents 320, 334, 348, and 364.

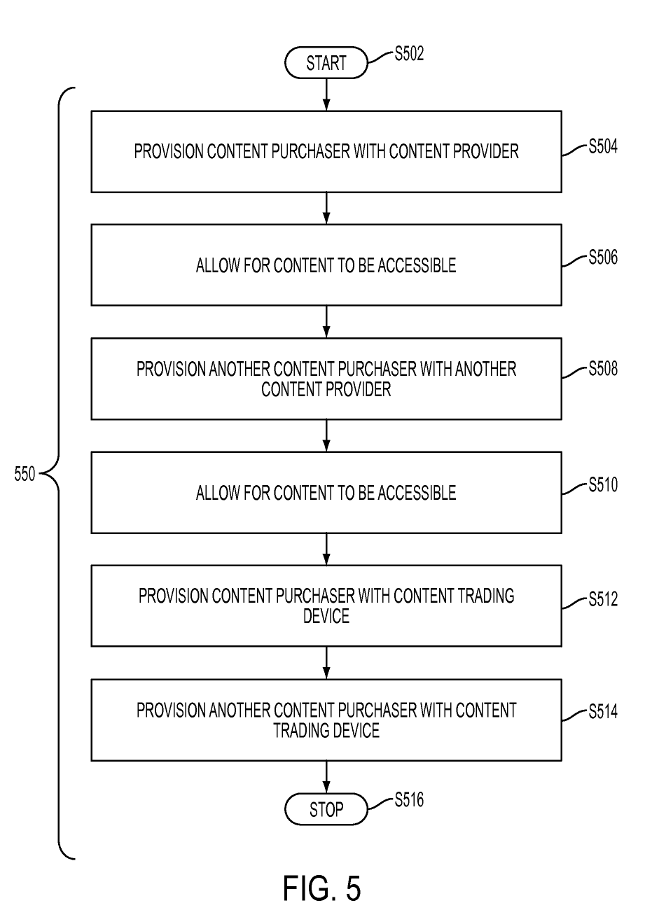

The operation of FIG. 4 is best described with reference to the process shown in FIG. 5.

FIG. 5 illustrates a content transaction process 500 between content trading device 102, first content provider 104, second content provider 106, first content purchaser 302 and second content purchaser 402.

After content transaction process 500 starts (S502), a content purchaser provisions to content provider (S504). For example, first content purchaser 302 is provisioned to first content provider 104 via a certificate or a digital identification.

The provisioning allows for content to be accessible to the content purchaser (S506). For example, first content purchaser 302 is able to go to first content provider 104 to download content and its license.

In order to allow for multiple content providers and content purchasers, another content purchaser provisions to another content provider (S508). For example, second content purchaser 402 is provisioned to content provider 106 using a certificate or a digital identification.

The provisioning allows for content to be accessible for another content purchaser (S510). For example, second content purchaser 402 is able to go to second content provider 106 to download content and its license.

In order to facilitate transactions between multiple content purchasers, a content purchaser provisions to content trading device 102 (S512). For example, first content purchaser 302 is provisioned to content trading device 102 using a digital certificate.

In order to facilitate transactions between multiple content purchasers, another content purchaser provisions to content trading device 102 (S514). For example, second content purchaser 402 is provisioned to content trading device 102 using a digital certificate. Content transaction process 500 ends at 5514.

FIGS. 4 and 5 provide a content transaction process with multiple content providers and multiple content purchasers. As shown in the previous figures, content trading device 102 is needed to facilitate transactions of unused quantified digital rights. Content trading device 102 may use a pricing list to coordinate these transactions.

FIG. 6 illustrates an exemplary pricing list that is stored on content trading device 102.

The pricing list 600 contains information regarding the content, digital right type of the content and quantified digital rights of the content that first content provider 104 and second content provider 106 have agreed to allow content trading device 102 to sell.

Pricing list 600 may also be used in the sale of digital rights from content purchasers to content trading device 102, as is shown in FIG. 7.

With reference to the foregoing figures, another embodiment of the present invention details the sale of digital rights from a content purchaser, such as first content purchaser 302 or second content purchaser 402, to content trading device 102 is shown in FIG. 7.

In FIGS. 7-10, content trading device 102, first and second content purchasers 302 and 402, and first and second content providers 104 and 106 use IPRM. IPRM is a rights management bureau that aids in governing downloaded digital content that contains associated rights. IPRM has the benefit of incorporating the ESBroker protocol for key management. Along with ESBroker, IPRM also includes KDC (key distribution center) server, Keystore, SRO generation, and the Security Agent. First and second content purchasers 302 and 402 are empowered by IPRM in order to provide cryptographic protection for its contents and understand SROs sent by content trading device 102. The content purchasers also need crypto agents 364 and 418 to generate the license locally. The first and second content provider 104 and 106 are empowered by IPRM, in order to receive and interpret SROs and send necessary content keys and rights to the content purchasers.

FIG. 7 illustrates content sale process 700, which involves the sale of digital rights from a content purchaser, such as first content purchaser 302, to content trading device 102.

After content sale process 700 starts (S702), content trading device 102 is empowered with IPRM (S704). Subsequently, KDC is installed on content trading device 102. First content purchaser 302 has been previously provisioned to the KDC of content trading device 102 via an Init Principal Request.

In response, first content purchaser 302 receives a reply (S706). This reply is an Init Principal Reply from the KDC. License validation server 318 and points management server 316 are provisioned to the KDC. License validation server 318 and points management server 316 each send a Service Key Request to the KDC.

In response, KDC sends reply (S708). This reply is a Service Key Reply to license validation server 318 and point management server 316. First content purchaser 302 contacts the KDC to obtain a Ticket Granting Ticket (TGT), using an Application Server (AS) Request/Reply message.

First content purchaser 302 receives a reply from KDC (S710). The reply contains the TGT. First content purchaser 302 uses the TGT to contact the ESBroker's Ticket-Granting Server (TGS) when it wishes to contact license validation server 318. First content purchaser 302 sends a TGS request message, which has the TGT embedded in it.

The TGS proceeds to send a ticket (S712). The ticket is a service ticket in a TGS Reply Message to first content purchaser 302. The service ticket is a ticket to license validation server 318.

First content purchaser 302 sends an Intent to Sell message (S714). This is done via a Key Request Message to license validation server 318. This message contains the service ticket to license validation server 318, it also contains the license to MOVIE X and the Intent to Sell (using the field Encrypted DOI).

License validation server 318 validates the signature of the Message Key Request (S716). This is done upon receiving the Message Key Request and then processing portion 314 processes the intention of the message as an intent to sell.

License validation server 318 determines whether the license validation was successful or not (S718).

If the license validation is successful, it must be determined whether the license was issued by first content provider 104 or content trading device 102 (S720). This is done via processing portion 314.

In the case the license was issued by content trading device 102, content database 308 is checked (S722). License validation server 318 uses the transaction number and the movie title from the license to check the record in content database 308 to match against any previous transaction. The process then proceeds to S728.

In the case the license was issued by first content provider 104, pricing list 600 must be checked (S724). License validation server 318 extracts from the license the movie's name and the type of digital rights associated with it. License validation server 318 then checks that the request falls in pricing list 600 of content trading device 102.

If the request falls in the pricing list 600 (S726), license validation server 318 sends a key request (S728). This is a KeyRequest Message to point management server 316. The KeyRequest Message contains a DOI which contains the following fields: the client principal name and realm (the name and realm of first content purchaser 302), the indication flag that is an intent to sell, the movie title and the digital right type associated with the license, the number of points that digital right type (quantified digital rights) associated with the license, and the number of points that digital rights is worth from the current pricing list 600. Prior to sending the KeyRequest, license validation server 318 must send a TGS request to the KDC to obtain a ticket to contact points management server 316. The ticket will contain the necessary security parameters to generate the session key between license validation server 318 and points management server 316. License validation server 318 can use the session key to encrypt the DOI. Upon receiving the KeyRequest Message, points management server 316 decrypts the message and then parses the information inside the message.

The next step requires the rights to be verified (S730). Points management server 316 accesses content database 354 of first content purchaser 302 with first content provider 104 to verify that first content purchaser 302 does possess the right at one time or not. The rights showed up in the license may be less than that specified in the license due to consumption by first content purchaser 302.

Points management server 316 then determines if the verification is successful or not (S732).

If the verification is successful, points are deposited (S734). Content trading device 102 will deposit the requested numbers of points less any commission into the account of first content purchaser 302. Points management server 316 increases its inventory for the digital right type. Points management server 316 also sends a KeyReply Message to license validation server 318. The reply message will contains a DOI, the DOI contains the fields: name, realm, the movie title and the quantified digital rights that was sold, and an indication that the transaction is successful or not. The DOI is encrypted with the session key. Points management server 316 also updates content database 354 of first content purchaser 302.

License validation server 318 receives a key reply. The key reply is a KeyReply Message from the points management server 316 (S736).

License validation server 318 determines if the transaction was successful (S738).

In the case where the transaction was successful, content trading device 102 downgrades the license (S740). This is done generating an SRO that represents the downgraded rights and sending the SRO to first content purchaser 302 via the Key Reply Message (using the field EncryptedDOI).

In the case where the transaction was unsuccessful, a reason for failure message is sent (S742). License validation server 318 sends a Message Key Reply to first content purchaser 302, but without the SRO, it will just contain the information that the transaction was not able to go through and the reason for the failure if it is appropriate.

An update to the digital rights is then performed (S742). Crypto agent 364 of first content purchaser 302 receives and decrypts the Message Key Reply and decrypts the EncryptedDOI attribute to obtain an updated SRO. The SRO is used to update the remaining rights of the license locally. Process 700 then ends (S744).

In this figure, first content purchaser 302 may be charged a commission and content trading device 102 may only accept the type of digital rights that are listed in pricing list 600. The sale of digital rights to content trading device 102 is just one type of transaction, the next figure details the purchase of digital rights from content trading device 102.

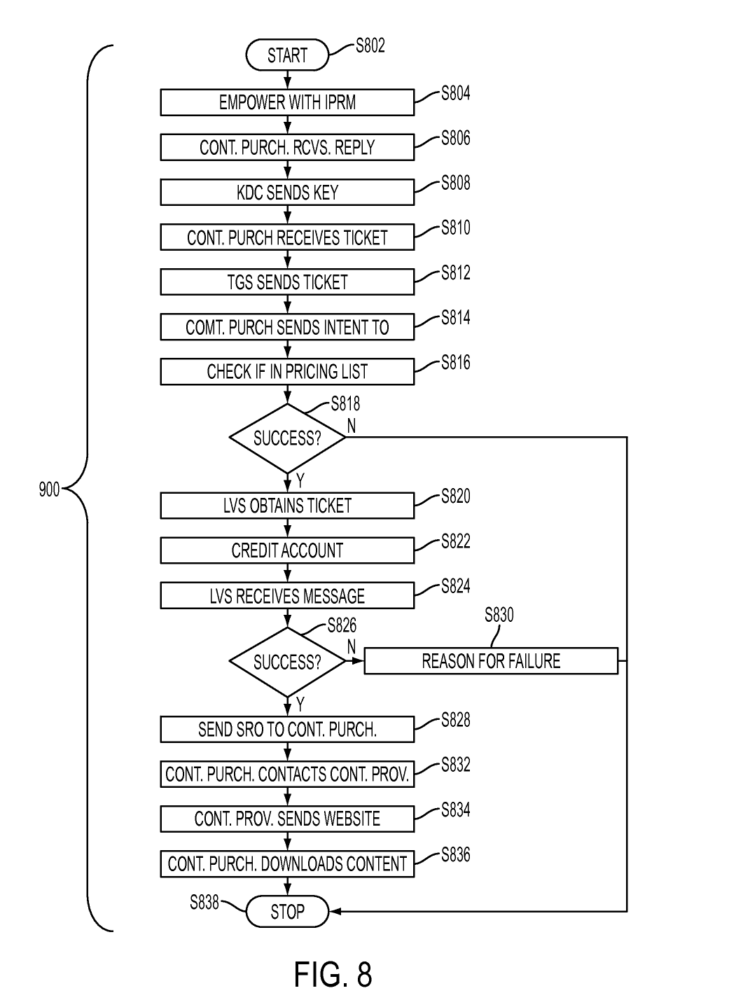

With reference to the foregoing figures and FIG. 8, an alternative embodiment of the present invention is illustrated by content purchasing process 800, which details the purchase of digital rights from content trading device 102 to first content purchaser 302.

After content sale process 800 starts (S802), content trading device 102 is empowered with IPRM (S804). Subsequently KDC is installed on content trading device 102. First content purchaser 302 has been previously provisioned to the KDC of content trading device 102 via an Init Principal Request.

In response, first content purchaser receives a reply (S806). The reply is an Init Principal Reply from the KDC. License validation server 318 and points management server 316 are provisioned to the KDC. License validation server 318 and points management server 316 each send a service key request to the KDC.

In response, KDC sends a key (S808). The key is a service key reply to license validation server 318 and point management server 316. First content purchaser 302 contacts the KDC to obtain a TGT using an AS Request/Reply message.

First content purchaser 302 receives a ticket (S810). The ticket is in a reply from KDC, and is a TGT. First content purchaser 302 uses the TGT to contact the ESBroker's Ticket-Granting Server when it wishes to contact license validation server 318. First content purchaser 302 sends a TGS request message, which has the TGT embedded in it.

The TGS sends a ticket to first content purchaser 302 (S812). The ticket is in a TGS Reply Message to first content purchaser 302. The ticket is service ticket to the license validation server 318.

First content purchaser 302 sends an Intent to Purchase (S814). First content purchaser 302 sends a Key Request Message to license validation server 318, this message contains the service ticket to license validation server 318, it also contains the Intent to Purchase together with the information on the movie title and the digital right type (using the field Encrypted DOI). Upon receiving the Message Key Request, license validation server 318 decrypts the message, validates the signature of the Message Key Request and then processing portion 314 processes the intention of the message as an Intent to Purchase. License validation server 318 decrypts the EncryptedDOI field to extract the movie's name and the type of rights requested by first content purchaser 302.

It is then necessary to check the pricing list (S816). License validation server 318 checks that the request falls in pricing list 600 of content trading device 102.

If the request falls in the pricing list (S818), license validation server 318 also sends the KeyRequest Message to points management server 316. The KeyRequest Message contains a specific DOI object which consists of the following attributes: the Client Principal Name and Realm (Name and Realm of first content purchaser 302) and the indication flag that it is an Intent To Purchase and the movie title and the digital right type requested by the first content purchaser 302, and the numbers of points that the digital rights are worth (quantified digital rights) from the current pricing list 600.

License validation server 318 obtains a ticket (S820). Prior to sending the KeyRequest, license validation server 318 must send a TGS request to the KDC to obtain a ticket to contact points management server 316. The ticket will contain the necessary security parameters to generate a session key between license validation server 318 and points management server 316. License validation server 318 can use the session key to encrypt the DOI.

First content purchaser's 302 account is credited (S822). Upon receiving the KeyRequest Message, points management server 316 decrypts the encrypted DOI and then parses the information inside it and decreases the requested numbers of points, less any commission, from the account of first content purchaser 302. Points management server 316 also decreases its inventory for the digital right type. Points management server 316 also sends a KeyReply Message to license validation server 318. The reply message will contain a DOI which consists of the following fields: name, realm, the movie title and the digital rights type that was requested and an indication that the transaction is successful or not of first content purchaser 302. The DOI is also encrypted by the Session Key between points management server 316 and license validation server 318. Points management server 316 also adds the new digital rights of first content purchaser 302 to content database 354 of first content purchaser 302

License validation server 318 receives a message (S824). The message is a KeyReply Message from points management server 316.

License validation server 318 determines if the transaction was successful or not (S826).

In the case that the transaction was successful, a SRO is sent to first content purchaser 302 (S828). A SRO is created for the movie title, the requested digital right type and is sent to first content purchaser 302 via a Key Reply (using the field EncryptedDOI). The process then continues to S832.

If the KeyReply Message from points management server 316 indicates that the transaction is unsuccessful, license validation server 318 will send a Key Reply to first content purchaser 302, but without the SRO, it will just contain the information that the transaction was not able to go through and the reason for the failure if it is appropriate (S830).

First content purchaser 302 contacts first content provider 104 (S832). First content purchaser 302 sends a TGS Request to the KDC to request for the service ticket to cache server 330 of first content provider 104. Upon receiving a TGS Reply and obtained a service ticket to cache server 330 of first content provider 104, first content purchaser 302 will send a KeyRequest Message to cache server 330 of first content provider 104 with the SRO encrypted in the EncryptedDOI field of the message. Cache server 330 of first content provider 104 decrypts the message and the Encrypted DOI to retrieve the SRO. License validation server 332 of first content provider 104 generates a subkey and encrypts the content of the movie requested. The encrypted content is put on an ftp (File Transfer Protocol) site to be downloaded by first content purchaser 302.

First content provider 104 sends the website where the content is located (S834). Cache server 330 sends a KeyReply Message to first content purchaser 302 to indicate the ftp site where the encrypted content is stored.

First content purchaser 302 is able to download the content (S836). Crypto agent 364 of first content purchaser 302 receives the Key Reply Message and extracts the ftp site. First content purchaser 302 may go to the site and downloaded the encrypted content. Crypto agent 364 uses the key to generate the license, which contains the movie title, the rights type and the transaction ID. The content can be decrypted by crypto agent 364 using the key in the license (S836). Process 800 ends at 5838.

In this figure, first content purchaser 302 may be charged a commission. Content trading device 102 may only provide the type of digital rights that are listed in pricing list 600. If content trading device runs out of a certain type of rights for a particular movie for a particular content provider, the transaction of first content purchaser 302 cannot go through until content trading device 102 advertises that it has obtained some more of the type of rights in stock from another owner.

The previous figure illustrated the purchase of digital rights from content trading device 102. The next figure illustrates a transfer of digital rights between known content purchasers.

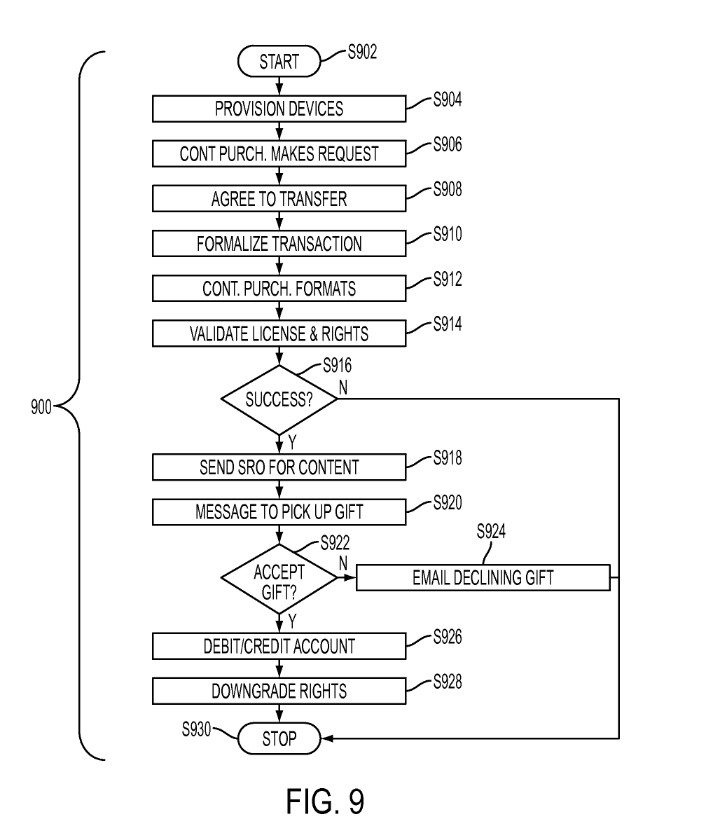

With reference to the foregoing figures and FIG. 9, an alternative embodiment of the present invention is illustrated by content gifting process 900, which details the gifting of digital rights from first content purchaser 302 to second content purchaser 402, when first content purchaser 302 knows second content purchaser 402.

After content gifting process 900 starts (S902), all of the devices are provisioned (S904). Second content purchaser 402 is a subscriber to first content provider 104, while first content purchaser 302 is a subscriber to second content provider 106. Both second content purchaser 402 and first content purchaser 302 are provisioned to content trading device 102. Also, first content purchaser 302 has gone through the necessary steps to obtain a TGT to talk to KDC of content trading device 102. First content purchaser 302 has also gone through the necessary steps to obtain a service ticket to talk to license validation server 318 of content trading device 102 and points management server 316.

Second content purchaser 402 makes a request (S906). Second content purchaser 402 communicates to first content purchaser 302 to request to watch MOVIE X—right type II—worth 60 points according to pricing list 600.

First content purchaser 302 agrees to transfer (S908). In this case, first content purchaser agrees to transfer 60 points to second content purchaser 402 as a gift.

The transaction terms are then finalized (S910). First content purchaser 302 browses its own remaining digital rights list managed by its crypto enhanced license management server 362. First content purchaser 302 decides to transfer 60 points to second content purchaser 402 by selling its digital rights for first content provider 104 MOVIE X—right type 2—worth 80 points, according to pricing list 600, to content trading device 102. First content purchaser 302 also wants the remaining 20 points (80-60) to be converted to first content provider 104 MOVIE X—right type 4—worth 20 points (S910).

First content purchaser 302 formats information (S912). Prior to contacting content trading device 102, crypto agent 364 of first content purchaser 302 will format the necessary information into a Key Request. The Key Request contains a DOI object, which includes an intent to gift to second content purchaser 402, the name in the certificate of second content purchaser 402 which is registered with content trading device 102, and the license for MOVIE X—type 2 in the form of an SRO. Prior to sending the DOI to content trading device 102, crypto agent 364 of first content purchaser 302 will encrypt the DOI object using a session key inside a service ticket between first content purchaser 302 and license validation server 318. License validation server 318 decrypts the message and the DOI using the session key inside the service ticket.

License validation server 318 will validate the license as discussed above with reference to FIG. 3 (S914).

License validation server 318 determines whether the validation is successful (S916).

If the validation is successful, an SRO for the content is sent (S918). License validation server 318 converts the digital right of first content purchaser 302 to MOVIE X—right type 4—worth 20 points and updates the digital right record for first content purchaser 302. Content trading device 102 also may charge a commission from the account of first content purchaser 302. Content trading device 102 also deposits 60 points into the account of second content purchaser 402. Any charging of commission is accomplished by sending a Key Request from license validation server 318 to points management server 316. Upon a successful Key Reply from points management server 316, license validation server 318 will generate a SRO for second content purchaser 402. The SRO contains the right to watch movie X—right type B-worth 60 points. Additionally license validation server 318 will generate a SRO for first content purchaser 302. This SRO contains the right to watch movie X—right type 4-worth 20 points.

License validation server 318 sends a message to pick up gift (S920). The message is an email via transmitting portion 312 to second content purchaser 402 to pick up the gift. Second content purchaser 402 will send a Key Request to license validation server 318 requesting to pick up the gift or to decline the gift.

If second content purchaser 402 chooses to decline the gift (S922), it will have to send an email to express its will to decline the gift (S924).

If the gift is accepted accounts are debited and credited (S926). If license validation server 318 receives a Key Request from second content purchaser 402 to accept the gift, it will send a KeyRequest to points management server 316 to deduct the 60 points from the account of second content purchaser 402 account (these are the 60 points which second content purchaser 402 has obtained from first content purchaser 302). If the Key Reply from points management server 316 is successful, license validation server 318 will send a Key Reply to second content purchaser 402, which contains the SRO. Second content purchaser 402 will have to use the SRO to contact cache server 344 of second content provider 402 to obtain the content. Crypto agent 418 of second content purchaser 402 will generate the license locally using the SRO obtained from license validation server 318.

Next, first content purchaser's 302 rights are downgraded (S928). License validation server 318 sends the SRO to first content purchaser 302. Crypto agent 364 of first content purchaser 302 will update the license of first content purchaser 302 for movie X, so that first content purchaser 302 now has a downgraded right (S928). The process ends at 5930.

In this figure, first content purchaser 302 gives second content purchaser 402 quantified digital rights. This is done by first content purchaser 302 first selling digital rights to content trading device 102 and then transferring a portion of the resulting sale to second content purchaser 402. Here second content purchaser 402 uses the gift to purchase digital content, alternatively second content purchaser 402 could have saved the gift for future use. Also first content purchaser 302 could have made a gift to themselves. For example, if first content purchaser 302 has Movie Y—right type 3—worth 20 points, according to pricing list 600, encrypted with DRM1 and sells that to content trading device 102. First content purchaser 302 may use the sale amount to purchase Movie Y—right type III—worth 20 points, according to pricing list 600, encrypted with DRM2. Effectively this is the transfer from rights from one DRM to another using content trading device 102 as a facilitator.

The previous figure detailed the transfer of rights between known content purchasers, the next figure details the transfer of rights between unknown content purchasers.

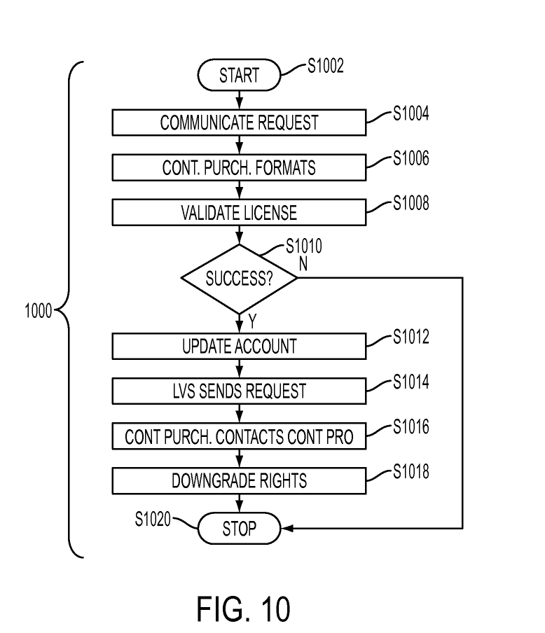

With reference to the foregoing figures and FIG. 10, an alternative embodiment of the present invention is illustrated by content transferring to an unknown party process 1000, details the transfer of digital rights from the first content purchaser 302 to the second content purchaser 402, when the first content purchaser 302 does not know the second content purchaser 402.

After content transferring to an unknown party process 1000 starts (S1002), second content purchaser 402 communicates a request (S1004). Second content purchaser 402 is a subscriber to second content provider 106, while first content purchaser 302 is a subscriber to first content provider 104. Second content purchaser 402 communicates to first content purchaser 302 to request to purchase the digital right to watch second content provider 106—MOVIE X—right type II—worth 60 points, according to pricing list 600. Also assume that first content purchaser 302 currently owns digital rights for first content provider 104 MOVIE X—right type 2—worth 80 points, according to pricing list 600. First content purchaser 302 also wants the remaining 20 points (80-60) to be converted to first content provider 104 MOVIE X—right type 4—worth 20 points, according to pricing list 600.

First content purchaser 302 formats information (S1006). Prior to contacting content trading device 102, crypto agent 364 of first content purchaser 302 formats the necessary information into a Key Request. The Key Request contains a DOI object which consists of an intent to transfer his digital rights for MOVIE X to second content purchaser 402, it also contains the name of second content purchaser 402 in the certificate, which is registered with content trading device 102, his license for MOVIE X and the remaining rights in the form of an SRO. Prior to sending the DOI to content trading device 102, crypto agent 364 of first content purchaser 302 encrypts the DOI object using a session key inside a service ticket between first content purchaser 302 and license validation server 318. License validation server 318 decrypts the message and the DOI using the session key inside the service ticket.

License validation server 318 then validates the license (S1008) and it is then determined whether the validation is successful (S1010).

If it is successful, accounts are updated (S1012). License validation server 318 converts the digital right of first content purchaser 302 to MOVIE X—right type 4—worth 20 points, according to pricing list 600, and updates the digital right record for first content purchaser 302. Content trading device 102 may also charge a commission from the account of first content purchaser 302. Any charging of commission is accomplished by sending a Key Request from license validation server 318 to points management server 316. Points management server 316 will transfer 60 points from the account of second content purchaser 402 to the account of first content purchaser 302. Upon a successful Key Reply from points management server 316, license validation server 318 will generate a SRO for second content purchaser 402, which contains the right to watch movie X—right type B-worth 60 points, at the same time it will generate a SRO for first content purchaser 302, which contains the right to watch movie X—right type 4-worth 20 points.

License validation server 318 sends request (S1014). License validation server 318 sends an email message via transmitting portion 312 to second content purchaser 402 to pick up the SRO. In response, second content purchaser 402 sends a Key Request to license validation server 318 requesting to pick up the SRO.

Second content purchaser 402 contacts second content provider 106 (S1016). When license validation server 318 receives a Key Request from second content purchaser 402 requesting to pick up the SRO for MOVIE X, license validation server 318 sends a Key Reply to second content purchaser 402, which contains the SRO. Second content purchaser 402 uses the SRO to contact cache server 344 of second content provider 106 to obtain the content. Crypto agent 418 of second content purchaser 402 generates the license locally using the SRO obtained from license validation server 318 (S1016).

First content purchaser's 302 rights are downgraded (S1018). License validation server 318 sends the SRO to first content purchaser 302. Crypto agent 364 of first content purchaser 302 updates the license of first content purchaser 302 for movie X, so that first content purchaser 302 now has a downgraded right (S1018). The process ends at S1020.

This form of a transfer of a license is different from gifting. The second content purchaser 402 has to give an agreed number of points to the first content purchaser 302 in exchange for the remaining rights in a license owned by the first content purchaser 302. The number of points that is to be exchanged is determined by pricing list 600 of content trading device 102 or any amount which is agreed between first content purchaser 302 and second content purchaser 402 and in the latter case the commission is fixed charge of certain points.

In this figure, first content purchaser 302 is responsible to find its purchaser, second content purchaser 402. The transaction appears to be the transfer of rights from a first DRM to a second DRM directly, but in effect, first content provider 104 and second content provider 106 never provide any means of transfer of digital rights from one type to another, what in effect is happening is the selling of rights issued by the first DRM from first content purchaser 302 to content trading device 102 and the purchasing of rights issued by a second DRM from content trading device 102 by content purchaser 402.

Presently, owners of unused quantified digital rights and potential buyers of unused quantified digital rights had no marketplace. This content trading device enables transactions involving quantified digital rights amongst content providers and content purchasers is achieved via aspects of the present invention. Specifically, this is achieved by the use of digital keys and quantified digital rights communicated between the content trading device and content purchasers and providers as shown in FIG. 3.

Some or all of the operations set forth in FIGS. 2, 5 and 7-10 may be contained as a utility, program, or subprogram, in any desired computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices. Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a digital content provider and a content purchaser, the content provider being operable to provide digital content and a first digital key, the digital content having quantified digital rights associated therewith, the content purchaser being operable to use the digital content in accordance with the digital rights upon receipt of the digital content and a second key, said device comprising:
a receiving portion operable to receive the digital content and the first digital key from the digital content provider;
a security portion operable to access the digital content with the first digital key;
a content database operable to store the digital content;
an interface portion operable to offer to the content purchaser the digital content in accordance with the quantified digital rights and to enable the content purchaser to purchase the digital content in accordance with purchased quantified digital rights that have a quantity that is no more than the quantity of the quantified digital rights; and
a transmitting portion,
wherein said security portion is further operable to encrypt the digital content with a second digital key such that the content purchaser may use the purchased digital content in accordance with the purchased quantified digital rights,
wherein said transmitting portion is operable to transmit the encrypted digital content and the second digital key to the content purchaser.

2. The device of claim 1, wherein said interface portion is further operable to offer to purchase, from the content purchaser, remaining quantified digital rights that have a quantity that is no more than the quantity of the purchased quantified digital rights.

3. The device of claim 2, wherein said a receiving portion is further operable to receive the remaining quantified digital rights from the content purchaser.

4. The device of claim 3, wherein said interface portion is further operable to offer the digital content in accordance with the quantified digital rights, minus the purchased quantified digital rights and plus the remaining quantified digital rights and to enable a second purchase of the digital content in accordance with second purchased quantified digital rights that have a quantity that is no more than the quantity of the quantified digital rights, minus the purchased quantified digital rights and plus the remaining quantified digital rights.

5. The device of claim 4, wherein said security portion is further operable to encrypt the digital content with a third digital key associated with the second purchase.

6. The device of claim 5, wherein said transmitting portion is operable to transmit the encrypted digital content and the third digital key.

7. A method trading digital content rights with a digital content provider and a content purchaser, the content provider being operable to provide digital content and a first digital key, the digital content having quantified digital rights associated therewith, the content purchaser being operable to use the digital content in accordance with the digital rights upon receipt of the digital content and a second key, said method comprising:
receiving, via a receiving portion, the digital content and the first digital key from the digital content provider;
accessing, via a security portion, the digital content with the first digital key;
storing, via a content database, the digital content;
offering, via an interface portion, to the content purchaser the digital content in accordance with the quantified digital rights;
enabling, via the interface portion, the content purchaser to purchase the digital content in accordance with purchased quantified digital rights that have a quantity that is no more than the quantity of the quantified digital rights;
encrypting, via the security portion, the digital content with a second digital key such that the content purchaser may use the purchased digital content in accordance with the purchased quantified digital rights; and
transmitting, via a transmitting portion, the encrypted digital content and the second digital key to the content purchaser.

8. The method of claim 7, further comprising offering, via the interface portion, to purchase, from the content purchaser, remaining quantified digital rights that have a quantity that is no more than the quantity of the purchased quantified digital rights.

9. The method of claim 8, further comprising receiving, via the receiving portion, the remaining quantified digital rights from the content purchaser.

10. The method of claim 9, further comprising:
offering, via the interface portion, the digital content in accordance with the quantified digital rights, minus the purchased quantified digital rights and plus the remaining quantified digital rights; and
enabling, via the interface portion, a second purchase of the digital content in accordance with second purchased quantified digital rights that have a quantity that is no more than the quantity of the quantified digital rights, minus the purchased quantified digital rights and plus the remaining quantified digital rights.

11. The method of claim 10, further comprising encrypting, via the security portion, the digital content with a third digital key associated with the second purchase.

12. The method of claim 11, further comprising transmitting, via the transmitting portion, the encrypted digital content and the third digital key.

13. A device-readable media having device-readable instructions stored thereon, the device-readable instructions being capable of instructing a device to perform a method of trading digital content rights with a digital content provider and a content purchaser, the content provider being operable to provide digital content and a first digital key, the digital content having quantified digital rights associated therewith, the content purchaser being operable to use the digital content in accordance with the digital rights upon receipt of the digital content and a second key, said method comprising:
receiving, via a receiving portion, the digital content and the first digital key from the digital content provider;
accessing, via a security portion, the digital content with the first digital key;
storing, via a content database, the digital content;
offering, via an interface portion, to the content purchaser the digital content in accordance with the quantified digital rights;
enabling, via the interface portion, the content purchaser to purchase the digital content in accordance with purchased quantified digital rights that have a quantity that is no more than the quantity of the quantified digital rights;
encrypting, via the security portion, the digital content with a second digital key such that the content purchaser may use the purchased digital content in accordance with the purchased quantified digital rights; and
transmitting, via a transmitting portion, the encrypted digital content and the second digital key to the content purchaser.

14. The device-readable media of claim 13, the device-readable instructions being capable of instructing the device to further perform offering, via the interface portion, to purchase, from the content purchaser, remaining quantified digital rights that have a quantity that is no more than the quantity of the purchased quantified digital rights.

15. The device-readable media of claim 14, the device-readable instructions being capable of instructing the device to further perform receiving, via the receiving portion, the remaining quantified digital rights from the content purchaser.

16. The device-readable media of claim 15, the device-readable instructions being capable of instructing the device to further perform:
offering, via the interface portion, the digital content in accordance with the quantified digital rights, minus the purchased quantified digital rights and plus the remaining quantified digital rights; and
enabling, via the interface portion, a second purchase of the digital content in accordance with second purchased quantified digital rights that have a quantity that is no more than the quantity of the quantified digital rights, minus the purchased quantified digital rights and plus the remaining quantified digital rights.

17. The device-readable media of claim 16, the device-readable instructions being capable of instructing the device to further perform encrypting, via the security portion, the digital content with a third digital key associated with the second purchase.

18. The device-readable media of claim 17, the device-readable instructions being capable of instructing the device to further perform transmitting, via the transmitting portion, the encrypted digital content and the third digital key.
